(19) United States
(12) Patent Application Publication
(10) Pub. No.: US 2007/0209204 A1
(43) Pub. Date: Sep. 13, 2007

(54) Hose Assembly Process, Device, and Product-by-Process

(76) Inventors: Daniel J. Chase, Parma, OH (US); Jeffrey J. Blake, Ravenna, OH (US); William C. Fisher, Cuyahoga Falls, OH (US); Garrett C. Humphrey, Akron, OH (US); Gregory W. Watson, Akron, OH (US); Benjamin M. Trace, Tallmadge, OH (US); Michael R. Swails, Madison, OH (US)

Correspondence Address: JOHN MOLNAR JR., PARKER-HANNIFIN CORPORATION, 6035 PARKLAND BOULEVARD, CLEVELAND, OH, 44124-4141, US

(21) Appl. No.: 11/538,079

(22) Filed: Oct. 3, 2006

Related U.S. Application Data
(60) Provisional application No. 60/780,717, filed on Mar. 9, 2006.

(51) Int. Cl. B23P 17/00; B23P 19/04

(52) U.S. Cl. 29/890.144; 29/234; 29/270; 29/271

(57) ABSTRACT

A process for assembling a rigid fitting to a flexible or elastic tube or hose within one of a portable, hand-held and/or mountable assembly device, including the steps of slip-fitting the fitting within a pusher member of the device that includes a torque-producing source capable Of converting input power into linear motion force; b. temporarily restraining a hose open end within the assembly device and; activating the torque-producing source to linearly advance the pusher member and fitting, relative to the restrained hose end, for physically inserting the fitting into the hose open end. Additional steps include: retraction of the pusher member and releasing the now-assemble hose and fitting assembly from the assembly device. Product-by-process claims and article claims, pertaining to the assembly device used in the process for assembling, are also set forth.

### CROSS-REFERENCE TO RELATED CASES

The present invention claims the benefit of the filing date of U.S. Provisional Application Ser. No. 60/780,717, filed Mar. 9, 2006, the disclosure of which is incorporated herein by reference.

### FIELD OF THE INVENTION

The present invention pertains to a process, a product-by-process and an assembly device, used in the product and process, wherein a rigid fitting is inserted into the open end of a flexible or elastic hose or tube via the use of one of a hand-held, portable, and mountable assembly device that includes a torque-producing source capable of converting input power into a linear motion for interference assembling the fitting with the hose open end.

### BACKGROUND OF THE INVENTION

Hoses and/or flexible tubings play a vital role in conveying fluid under pressure to a myriad of machinery and other industrial applications in many differing industries. Such hoses and their associated fittings are necessary to make the required hose-to-machinery connections and, being subject to wear and tear under often severe operating conditions, must frequently be replaced or serviced in the field where custom length hoses may not be readily available. Thus, specialized length hoses, due to necessity, are often produced directly on site. As a result of their generally heavy duty reinforced construction, the interference or press-fitting of a rigid end fitting into an adjoining end of a flexible but tough hose is often difficult to achieve, particularly under adverse outdoor working environments.

One known prior art commercial tool for making an end fitting-to-hose assembly takes the form of the “Push-Lok Cut-Off & Assembly Tool Model No. 881540” (Catalog 4400 US, October 2003), available from the Hose Products Division of the Parker Hannifin Corporation in Wickliffe, Ohio, U.S.A. While this tool is useful, it is neither of the hand-held type, nor readily portable, but rather functions as bench-type tool.

### SUMMARY OF THE INVENTION

Accordingly, in order to overcome the deficiencies of the prior art devices, assemblies and processes, the present invention utilizes a hand-held or mountable, portable, powered, device for inserting a rigid end fitting into the open end of a flexible hose. An assembly process, utilizing the device and a fitting/hose assembly produced via this process are also included in the present invention.

Specifically, a first embodiment of the present invention pertains to a process for assembling a fitting to a hose within a hand-held, portable and mountable device, wherein an insertable portion of the fitting is interference-fitted into an open end portion of the hose until the latter abuts an inner end of an exposed coaxial portion of the fitting, the process including the steps of: a. axially slip-fitting and centering at least a peripheral segment of the fitting exposed portion in a pusher member, with the insertable fitting portion extending axially outwardly from the pusher member; the pusher member being located within the device and operatively interconnected with a torque-producing source capable of converting input power into linear motion force; b. physically, temporarily restraining and centering the hose open end portion, within a restraining mechanism in the device in an axially spaced position away from but coaxial with the insertable fitting portion; and c. activating the torque-producing source to linearly advance the pusher member and fitting, relative to the restrained and centered hose open end portion, thereby physically inserting, in an interference-fit manner, the fitting insertable portion into the hose open end portion until the latter substantially abuts the inner end of the fitting exposed portion and thereby completing the process for assembling.

In a second version of this embodiment, step b. is performed prior to step a.

In another version thereof, the process for assembling further includes the step of linearly retracting the pusher member at least for a distance sufficient to release the peripheral segment of the fitting exposed portion from the pusher member. A variation thereof further includes the step of releasing the now-assembled hose and fitting from the device.

A differing version thereof further includes the steps of retracting and releasing the now assembled hose and fitting from the pusher member and the device, respectively.

In yet another version thereof, the torque-producing source is one of operator to produced, mechanically produced, electrically produced, electro-mechanically produced and pneumatically produced.

A second embodiment of the present invention pertains to a hose and fitting assembly assembled by the process of the first embodiment. A variation thereof pertains to a hose and fitting assembly assembled by the process of the second version of the previous embodiment.

A third embodiment of the present invention pertains to a hose and fitting assembly assembled, on site, via the device and the process of the first embodiment.

In a fourth embodiment thereof, a hose and fitting assembly assembled, on site, via the device and the process of the version of the first embodiment that further includes the steps of retracting and releasing the now assembled hose and fitting from the pusher member and the device, respectively.

A fifth embodiment of the present invention pertains to one of a hand-held, portable, and mountable device for assembling a rigid fitting to an elastic hose or tube via interference-fitting of an insertable portion of the fitting into an open end of the hose until the latter abuts an inner end of an exposed coaxial portion of the fitting, the device including: a. a housing including a hand-receiving portion; b. an actuatable power source, capable of converting input power into linear motion force, physically located within the housing, the power source having an axially-directed, retractable, output member; c, a pusher member, attached to an inner end of the output member, for axially retaining and centering, in a slip-fit manner, at least a peripheral segment of the fitting exposed portion, with the insertable fitting portion extending axially outwardly from the pusher member; d. the housing further including an integral generally semi-cylindrical housing extension, having a central cavity, axially aligned, concentric with, and centering the pusher member at an inner end thereof; and e. a peripheral restraining mechanism, affixed to an outer portion of the generally semi-cylindrical housing extension, for physically, temporarily, restraining and centering the hose open end portion away from but coaxial with the insertable fitting portion, wherein activating the power source linearly advances the pusher member and fitting, relative to the restrained and centered hose open portion, thereby pushing the fitting insertable portion into the hose open end portion.

In one version of the device, the pusher member is generally cylindrical and has an open end, remote from the output member. In a variation thereof, the pusher member has an interior shape and dimensions that at least approximate the exterior shape and dimensions of the peripheral segment of the fitting exposed portion, thereby providing temporary slip-fit restraining and centering of the peripheral segment.

In another version thereof, the source of torque is one of operator-supplied, mechanical, electrical, electro-mechanical, and pneumatic. In a variation thereof, the operator-supplied source of torque is in the form of hand actuation; with this hand actuation is preferably accomplished via a ratcheting mechanism.

In variation of the previous version, the source of torque includes electric drills, electric caulking guns and pneumatic caulking guns, with these sources preferably being cordless.

In a further version, the peripheral restraining mechanism takes the form of a pneumatic bladder.

In another version thereof, the peripheral restraining mechanism takes the form of self-adjusting multi-jaw hose/tube clamps.

In a differing version thereof, the housing extension, in the area of the central cavity, is provided with axially-spaced indicia markings indicating the preferred axial positionings, relative to each other, of the hose and fitting during the initial positionings thereof, so as to prevent excessive compression of the hose during the insertion of the fitting.

In yet further variations thereof, the device is hand-held; adapted to be mounted; and portable.

The previously-described advantages and features, as well as other advantages and features will become readily apparent from the detailed description of the preferred embodiments that follow.

### BRIEF DESCRIPTION OF THE DRAWINGS

FIG. 1 is a perspective view, at the initial stage of the assembly, of one end of a flexible hose to a separate, rigid, end fitting, prior to their insertion into the assembly device of the present invention.

FIG. 2 is a view, similar to that of FIG. 1, wherein the fitting (not visible here) is now recessed in a fitting holder and the one end of the hose is now retained in a restraining mechanism, both ready for assembly, within the assembly device.

FIG. 3 is a view, similar to that of FIG. 2, but now showing the completion of the hose-end to fitting assembly, after the actuation of an actuatable power source, still within the assembly device.

FIG. 4 is a view, similar to that of FIG. 3, showing the retraction of the fitting holder, with the completed hose-end to fitting assembly still being held by the restraining mechanism within the assembly device.

FIG. 5 is a view similar to that of FIG. 4, showing the removal of the completed hose-end to fitting assembly, after the release thereof from the restraining mechanism, of the assembly device.

FIG. 6 is an enlarged top plan view of a typical, conventional, prior art, rigid, end fitting that is adapted to be assembled with one end of a flexible hose via the assembly device of the present invention.

### DETAILED DESCRIPTION OF THE INVENTION

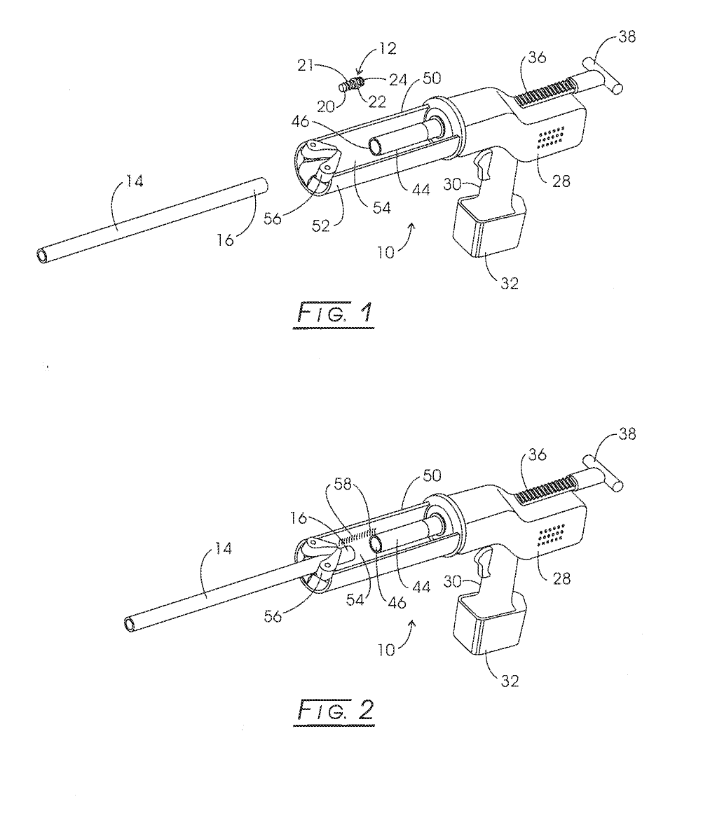

Referring now to the several drawings, illustrated in FIG. 1, in a perspective view, is a handheld or mountable device or mechanism 10 adapted for assembling a separate, rigid, prior art, fitting 12, best seen in FIG. 6, to one 16 of a hose or flexible/elastic tube 14. As previously noted, due to their generally heavy duty construction, the interference or press-fitting of end fitting 12 into an adjoining end 16 of an elastic, generally reinforced and tough hose 14 is often difficult to achieve, particularly under adverse outdoor working conditions.

Tube or hose fittings 12, of known constructions, are usually comprised of metallic or rigid plastic materials and are generally cylindrical in shape, having a smaller diameter multi-barbed inner end portion 20 that is designed to be physically forced into hose open end 16. Often, an adjoining larger diameter fitting center portion 22 is provided with a hexagonally arranged series of flat surfaces, serving as tool applying surfaces, which then merge into an axially adjoining threaded outer end portion 24, in a manner well known in the art. The exact shapes of fitting 12 are not important here, suffice it to say that nearly all such fittings utilize multiple axially-spaced, unidirectional barbs 21 whose reverse angulations function to facilitate assembly but resist disassembly, again in a manner well known in the art.

Turning now specifically to the portable, handheld and/or mountable device 10, it is in essence any desired type of a device having a housing 28 having a hand-holding or hand-receiving portion 30 that includes an operator-controlled power source 32 that is capable of converting any desired type of input torque or power into a controlled linear motion force. Typical examples of the hand-held devices or mechanisms 10 that are useful in the present invention include portable power tools such as electric drills and electrically or pneumatically driven caulking guns. What is important is that the power source includes an axially-directed driven output member 36 that can, preferably, be manually and/or automatically retracted, such as via an outer end handle portion 38+One example of the assembly device 10 of FIG. 1 is an adaptation of a battery powered, electrical motor driven, portable, caulking gun well known in the art. It is however important to understand that device or mechanism 10 is not restricted to being solely power operated and while this is preferred, in terms of operator convenience, speed and ease of operation, a known operator hand-actuated type of ratcheting mechanism is also acceptable.

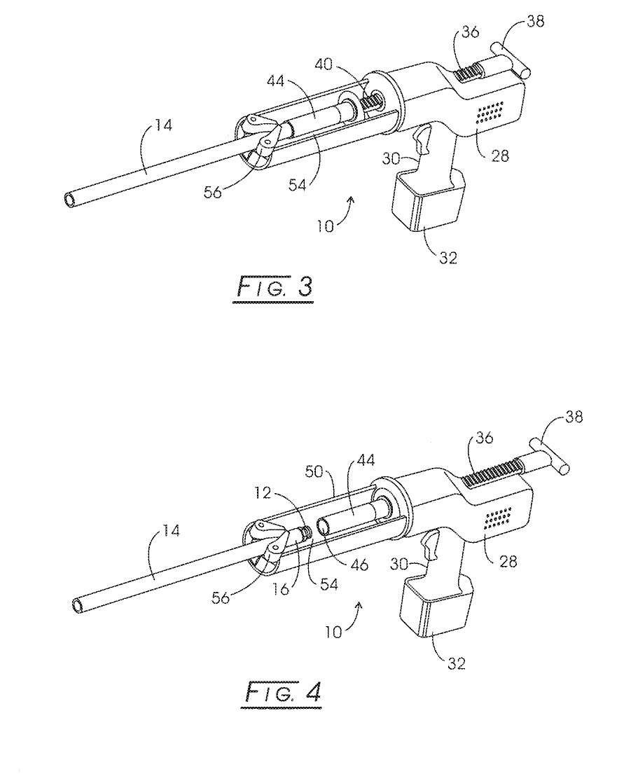

As best illustrated in FIG. 3, an inner end 40 of output member 36 is provided with an axially outwardly extending pusher member 44 of a generally tubular shape having a concentric central cavity or bore 46 (FIGS. 1, 2) with an inner diametral extent slightly greater than that of the corresponding fitting central threaded portion 24 and a depth or recess preferably of an extent approximately equal to the overall length of fitting 12+Thus, the size of cavity 46 permits the axial retention and centering therein, in a comfortable slip-fit or nesting manner, of fitting 12, wherein the outer axial end surface of fitting threaded portion 24 abuts the blind inner end surface of cavity 46, thereby effectively cradling fitting 12 therein. It should be understood that the exact shape or form of cavity or bore 46 will, of course, be dependent upon the specific exterior form and shape of fitting 12.

Also axially outwardly extending from housing 20, coaxial wit pusher member 44, is a semi-cylindrical housing extension or portion 50 whose axial outer end portion 52 is provided with a concentric, radially inwardly-directed, peripheral, annular, restraining mechanism 56 adapted for axially as well as peripherally restraining and centering, relative to pusher member cavity 46, of open end portion 16 of hose 14. The noted axial restraining occurs preferably only in one direction, namely in the axial direction opposing that of advancing output member 36 as will be explained in more detail hereinafter. Again, the exact form and shape of restraining member mechanism 56 is not limited to a particular shape or method of retention or restraining and could, for example, take the form of a pneumatic bladder, a self-adjusting hose/tubing clamp or any other means or mechanism having an inside diameter of a size sufficient to externally secure or hold hose 14 against slippage in an axial direction outwardly from housing extension 50, while preferably permitting the slip-fit passing of hose end portion 16 in the axial direction inwardly relative to housing extension 50 for assembly and removal purposes.

Focusing now on the assembly of hose 14 to fitting 12, or more precisely the interference or press fitting of hose end 16 and barbed portion 20 of fitting 12, as is progressively illustrated in FIGS. I to 5, shown initially in FIG. 1 is a portable device 10, either hand-held or capable of being mounted on a support, with device 10 including power source output member 36 and attached pusher member 44 being shown in axially fully-retracted positions. Fitting 12 and tube 14 are ready for insertion into device 10.

In the FIG. 2 illustration, the operator has slip-inserted fitting 12 (hidden from view here) into pusher member cavity 46 so that fitting barbed end portion 20 is axially outwardly extended therein. In addition, tube end portion 16 has been inserted, through restraining mechanism 56, into central cavity 54 of housing extension 50, spaced at a predetermined axial distance from the outer end of pusher member 44, with fitting 12 and hose end 16 being coaxially arranged. If desired, housing extension 50, in the area of central cavity 54, can be provided with a plurality of axially-spaced, preferably semi-circularly-directed, “smart” indexing or indicia markings 58 (shown schematically in FIG. 2) for both hose 14 and fitting 12 (in pusher member 44) that will indicate the correct or preferred axial locations, during initial loose positionings thereof, relative to each other, so as to prevent the excessive compression of hose or tube 14 during the insertion of fitting 12. Furthermore, such indicia markings 58 can include differing axial position indications, depending upon the hose/tube material constructions and the differing sizes thereof that can be accommodated in assembly device 10.

Progressing now to the FIG. 3 illustration, the operator has now actuated power source 32 of hand-held device 10, thereby causing output member 36, together with pusher member 44, to be axially outwardly displaced until fitting barbed portion 20 makes contact with tube end portion 16 and hereafter press or interference fitting the barbed inner portion 20 of fitting 12 fully into hose end 16, i.e., until hose end 16 abuts the adjoining end of fitting hex portion 22.

The FIG. 4 illustration differs from that of FIG. 3 only in that the operator has now retracted power source output member 36, via handle portion 38.

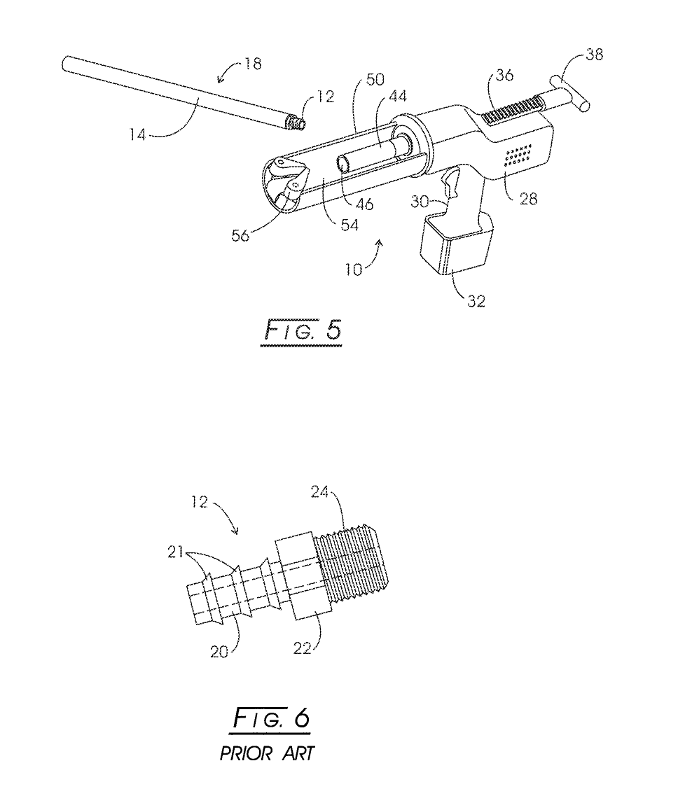

Finally, FIG. 5 illustrates the now-completed hose/fitting assembly 18, comprised of fitting 12 assembled with hose end 16, after the removal thereof from housing extension central cavity 54, with mechanism 10 now being ready for the next assembly cycle in the manner illustrated in FIG. 1.

It is deemed that one of ordinary skill in the art will readily recognize that the present invention fills real remaining needs in this art and will be able to affect various changes, substitutions of equivalents and various other aspects of the invention as described herein. Thus, it is intended that the protection granted hereon be limited only by the scope of the appended claims and their equivalents.

What is claimed is:

1. A process for assembling a rigid fitting to a flexible hose or tube within one of a hand-held, portable, and mountable device, wherein an insertable portion of said fitting is interference-fitted into an open end portion of said hose until the latter abuts an inner end of an exposed coaxial portion of said fitting, said process including the steps of:
a. axially slip-fitting and centering at least a peripheral segment of said fitting exposed portion in a pusher member, with said insertable fitting portion extending axially outwardly from said pusher member; said pusher member being located within said device and operatively interconnected with a torque-producing source capable of converting input power into linear motion force;
b. physically, temporarily restraining and centering said hose open end portion, within a restraining mechanism in said device in an axially spaced position away from but coaxial with said insertable fitting portion; and
c. activating said torque-producing source to linearly advance said pusher member and fitting, relative to said restrained and centered hose open end portion, thereby physically inserting, in an interference-fit manner, said fitting insertable portion into said hose open end portion until the latter substantially abuts the inner end of said fitting exposed portion and thereby completing said process for assembling.

2. The process for assembling of claim 1, wherein step b. is performed prior to step a.

3. The process for assembling of claim 1, further including the step of linearly retracting said pusher member at least for a distance sufficient to release said peripheral segment of said fitting exposed portion from said pusher member.

4. The process for assembling of claim 3, further including the step of releasing said now-assembled hose and fitting from said device.

5. The process for assembling of claim 1, further including the steps of retracting and releasing said now assembled hose and fitting from said pusher member and device, respectively.

6. The process for assembling of claim 1, wherein said torque-producing source is one of operator-produced, mechanically produced, electrically produced, electro-mechanically produced and pneumatically produced.

7. A hose and fitting assembly assembled by the process of claim 1.

8. A hose and fitting assembly assembled by the process of claim 2.

9. A hose and fitting assembly assembled, on site, via the device and the process of claim 1.

10. A hose and fitting assembly assembled, on site, via the device and the process of claim 5.

11. One of a hand-held, portable and mountable device for assembling a rigid fitting to a flexible hose or tube via interference-fitting of an insertable portion of said fitting into an open end of said hose until the latter abuts an inner end of an exposed coaxial portion of said fitting, said hand-held device including:
a housing including a hand-receiving portion;
b. an actuatable power source, capable of converting input power into linear motion force, physically located within said housing, said power source having an axially-directed, retractable, output member;
c. a pusher member, attached to an inner end of said output member, for axially retaining and centering, in a slip-fit manner, at least a peripheral segment of said fitting exposed portion, with said insertable fitting portion extending axially outwardly from said pusher member;
d. said housing further including an integral generally semi-cylindrical housing extension, having a central cavity, axially aligned, concentric wit, and centering said pusher member at an inner end thereof; and
c. a peripheral restraining mechanism, affixed to an outer portion of said generally semi-cylindrical housing extension, for physically, temporarily, restraining and centering said hose open end portion away from but coaxial with said insertable fitting portion, wherein activating said power source linearly advances said pusher member and fitting, relative to said restrained and centered hose open portion, thereby pushing said fitting insertable portion into said hose open end portion.

12. The device of claim 11, wherein said pusher member is generally cylindrical and has an open end, remote from said output member.

13. The device of claim 12, wherein said pusher member has an interior shape and dimensions that at least approximate the exterior shape and dimensions of said peripheral segment of said fitting exposed portion, thereby providing temporary slip-fit restraining and centering of said peripheral segment.

14. The device of claim 11, wherein said source of torque is one of operator-supplied, mechanical, electrical, electro-mechanical, and fluid-powered.

15. The device of claim 14, wherein said operator-supplied source of torque is in the form of hand actuation.

16. The device of claim 15, wherein said hand actuation is accomplished via a ratcheting mechanism.

17. The device of claim 14, wherein said source of torque includes electric drills, electric caulking guns and pneumatic caulking guns.

18. The device of claim 17, wherein said sources are cordless.

19. The device of claim 1 1, wherein said peripheral restraining mechanism takes the form of a pneumatic bladder.

20. The device of claim 11, wherein said peripheral restraining mechanism takes the form of self-adjusting multi-jaw hose/tube clamps.

21. The device of claim 11, wherein said housing extension, in the area of said central cavity, is provided with axially-spaced indicia markings indicating the preferred axial positionings, relative to each other, of said hose and fitting during the initial positionings thereof, so as to prevent excessive compression of said hose during the insertion of said fitting.

22. The device of claim 21, wherein said indicia markings are semi-circularly directed and include differing axial positionings depending upon the hose material compositions and/or sizes that can be accommodated within said device.

23. The device of claim 11, wherein said device is hand-held.

24. The device of claim 11, wherein said device is adapted to be mounted.

25. The device of claim 11, wherein said device is portable.
